(19) United States
(12) Patent Application Publication
(10) Pub. No.: US 2025/0264646 A1
(43) Pub. Date: Aug. 21, 2025

(54) PHOTOCHROMIC ELEMENT CONTAINING SURFACTANT AND MANUFACTURING METHOD FOR THE SAME

(71) Applicant: KOREA UNIVERSITY OF TECHNOLOGY AND EDUCATION INDUSTRY-UNIVERSITY COOPERATION FOUNDATION, Cheonan-si, Chungcheongnam-do (KR)

(72) Inventors: JinWoo BAE, Seoul (KR); JaEuk YOON, Yongin-si, Gyeonggi-do (KR); SuJeong PARK, Cheongju-si, Chungcheongbuk-do (KR); Jung Hwa HWANG, Daejeon (KR); HyeBhin YOON, Chungcheongnam-do (KR); Chan Ho SONG, Cheonan-si, Chungcheongnam-do (KR)

(73) Assignee: KOREA UNIVERSITY OF TECHNOLOGY AND EDUCATION INDUSTRY-UNIVERSITY COOPERATION FOUNDATION, Cheonan-si, Chungcheongnam-do (KR)

(21) Appl. No.: 18/857,181

(22) PCT Filed: Dec. 13, 2023
(86) PCT No.: PCT/KR2023/020485

§ 371 Date: Oct. 16, 2024

(30) Foreign Application Priority Data
Dec. 26, 2022 (KR) 10-2022-0184007

(51) Int. Cl. G02B 5/23; G02B 1/04; G02B 1/18; G02B 5/22

(52) U.S. Cl. CPC G02B 5/23; G02B 1/04; G02B 1/18; G02B 5/223

(57) ABSTRACT

There is provided a photochromic element containing a surfactant and a manufacturing method for the same, and more specifically, the present invention is characterized in that the photochromic element has excellent physical properties and excellent discoloration characteristics due to containing a surfactant, wherein the polymer resin includes a polymer resin selected from the group consisting of polydimethylsiloxane (PDMS), polyurethane, polyacryl, polyepoxy, polyester, polystyrene (PS), polyacrylate (PA), and combinations thereof.

### TECHNICAL FIELD

The present invention relates to a photochromic element containing a surfactant and a manufacturing method for the same, and more specifically, the present invention is characterized in that the photochromic element has excellent physical properties and excellent discoloration characteristics due to containing a surfactant.

The present invention is the result of research carried out with the support of the project ‘High-transparent and high-stretchable next-generation sensor using non-aqueous-based high-performance multifunctional ion-conductive and non-ion-conductive polymer gel, and application to electrochemical display element’ funded by the Korean government (Ministry of Science and ICT) from 2021.03.01 to 2024.02.29 through the National Research Foundation of Korea (No. 1711190086).

### BACKGROUND ART

A photochromic substance is a compound that absorbs light energy at a specific wavelength, which causes a change in molecular structure and, in this state, the color to be displayed externally changes. This substance has such properties that the molecular structure reversibly returns to the previous molecular structure in a case where the energy applied to the substance is interrupted.

In a case where such a photochromic substance as described above is composed of an inorganic substance such as a metal oxide, an alkali earth metal, a mercury compound, or a transition metal compound, the photochromic substance is very stable to external environments such as ultraviolet rays, oxygen, solvents, and the like. However, there is a limitation in that the utilization thereof is difficult because processing is very difficult. On the other hand, it is easy to utilize an organic photochromic dye such as benzopyran, a naphthopyran, spiropyran, spirooxazine, fulgimide, diarylethene, or an azo compound by dissolving it in a solvent or powdering it. However, the organic photochromic dye becomes unstable by light, oxygen, an acid, an organic solvent, or the like, and thus there is a limitation in terms of lack of durability.

The disadvantage of photochromic dyes is that, as previously described, the chemical molecular structure is destroyed by external environmental factors, which leads to a relatively easy progression of a side reaction that causes the photochromic properties due to light to disappear. As the cause of this side reaction, it is known that an oxidation reaction and the like by free radicals or reactive oxygen species proceed either alone or simultaneously to destroy the dye structure.

On the other hand, the spiropyran, which is the most common photochromic dye, has properties that the color thereof changes to blue in response to UV. Due to these properties, research has been carried out to add the spiropyran to various polymers.

In association with this, the most commonly used polymer is polydimethylsiloxane (PDMS), and there is an advantage in that in a case where spiropyran is mixed with the polydimethylsiloxane (PDMS), photochromic properties can be obtained, and a flexible element can be manufactured. However, the above-described polydimethylsiloxane (PDMS) has had difficulties in manufacturing stretchable elements since the elongation rate itself is not good.

Therefore, while researching to solve such a problems as described above, the inventors of the present invention found that in a case where a surfactant is additionally contained in the manufacturing of a photochromic element, the photochromic element not only has high flexibility and an improved elongation rate but also has excellent discoloration characteristics, whereby the present invention has been completed.

In association with this, Korean Patent Publication No. 10-2017-0014594 discloses “Organic thin film using fluorescent conjugated polymers and photochromic dyes, method for preparing the same and method for photo-responsible fluorescence patterning using said organic thin film”.

### DISCLOSURE OF THE INVENTION

### Technical Goals

The present invention provides a manufacturing method for a photochromic element containing a surfactant.

In addition, the present invention provides a photochromic element containing a surfactant.

### Technical Solutions

As a technical means to achieve the technical task described above, one aspect of the present invention provides,
in accordance with an embodiment of the present invention, a manufacturing method for a photochromic element, where the manufacturing method includes mixing a polymer resin and a curing agent; adding a photochromic dye to the resultant mixture; and adding a surfactant to the mixture to which the photochromic dye is added.

The polymer resin may include a polymer resin selected from the group consisting of polydimethylsiloxane (PDMS), polyurethane, polyacrylic, polyepoxy, polyester, polystyrene (PS), polyacrylate (PA), and a combination thereof.

The curing agent may include a substance selected from the group consisting of polydimethylsiloxane (PDMS), polyisocyanate, hexamethylene diisocyanate, ethylenimine, propylenimine, poly(ethylene glycol dimethacrylate) (PEGDMA), poly(ethylene glycol diactylate) (PEGDMA), dicumyl peroxide, dibenzoyl peroxide, tert-butylcumylperoxide, SYLGARD 184 elastomer curing agent, and a combination thereof

The photochromic dye may include a substance selected from the group consisting of spiropyran, spirooxazine, naphthopyran, fulgimide, azobenzene, and combinations thereof.

The surfactant may include a substance selected from the group consisting of Triton X-100 (trademark), myristyltrimethylammonium bromide, N-dodecyl-N,N-dimethyl-3-ammonio-1-propanesulfonate, a 3-(decyldimethylammonio propanesulfonate inner salt zwitterionic detergent, 3-(N,N-dimethylmyristylammonio)propanesulfonate, Thesit (registered trademark), n-dodecyl β-D-maltoside, octyl β-D-glucopyranoside, and combinations thereof

A content of the curing agent may be approximately 1 to approximately 30 parts by weight with respect to 100 parts by weight of the polymer resin.

A content of the photochromic dye may be approximately 0.1 to approximately 10 parts by weight with respect to 100 parts by weight of a mixture containing the polymer resin and the curing agent.

A content of the surfactant may be approximately 0.01 to approximately 2 parts by weight with respect to 100 parts by weight of the mixture containing the polymer resin and the curing agent.

In addition, in accordance with another embodiment,
a photochromic element contains a polymer resin, a curing agent, a photochromic dye, and a surfactant.

Discoloration of the photochromic element may be carried out within approximately 1 minute.

Decolorization of the photochromic element may be carried out within approximately 10 minutes.

In a case where the photochromic element is discolored, the photochromic element may exhibit a transmittance of approximately 45% to approximately 75% with respect to light having a wavelength of approximately 593 nm.

In a case where the photochromic element is discolored, the photochromic element may exhibit a transmittance change of approximately 30% or more with respect to light having a wavelength of approximately 593 nm based on a transmittance before discoloration.

The photochromic element may exhibit a tensile strain of approximately 350% or more based on a tensile strength of approximately 1 MPa.

In addition, in accordance with still another embodiment of the present invention, an artificial skin includes a photochromic element.

### Advantageous Effects

The photochromic element according to the present invention as described above may have improved physical properties such as flexibility and an elongation rate by containing a surfactant.

In addition, the photochromic element may have excellent discoloration characteristics and excellent decolorization characteristics.

### BRIEF DESCRIPTION OF DRAWINGS

FIG. 1 shows a synthesis process of spiropyran in accordance with an embodiment of the present invention;

FIG. 2 is a graph showing the absorbance of a photochromic element depending on a wavelength in accordance with another embodiment of the present invention;

FIG. 3 shows photographic images showing discoloration and decolorization of the photochromic element in accordance with another embodiment of the present invention;

FIG. 4 is a graph showing transmittance of a photochromic element in accordance with another embodiment of the present invention; and

FIG. 5 shows a stress-strain curve of a photochromic element in accordance with still another embodiment of the present invention.

### MODE FOR CARRYING OUT THE INVENTION

Hereinafter, the present invention will be described in more detail. However, the present invention can be implemented in various different forms. The present invention is not limited by examples described herein, but the present invention is only defined by the claims to be described later.

In addition, the terms used in the present invention are merely used to describe specific examples and thus are not intended to limit the present invention. A singular expression includes a plural expression unless it is definitely different contextually. Throughout the specification of the present invention, “including” a certain component means that other components may be further included rather than excluding other components, unless specified otherwise.

A first aspect of the present application provides
a manufacturing method for a photochromic element, where the manufacturing method includes mixing a polymer resin and a curing agent; adding a photochromic dye to the mixture; and adding a surfactant to a mixture to which the photochromic dye is added.

Hereinafter, the manufacturing method for a photochromic element according to the first aspect of the present application will be described in detail process by process.

First, in an embodiment of the present application, the above-described manufacturing method for a photochromic element may include mixing a polymer resin and a curing agent.

In an embodiment of the present application, the polymer resin may include, as a substance serving as a base for a photochromic element, a polymer resin selected from the group consisting of polydimethylsiloxane (PDMS), polyurethane, polyacryl, polyepoxy, polyester, polystyrene (PS), polyacrylate (PA), and a combination thereof, and according to an example of the present invention, polydimethylsiloxane (PDMS) may be used.

In this case, the polydimethylsiloxane (PDMS) may be represented by the following Chemical Formula 1.

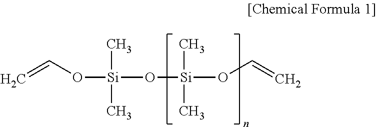

In an embodiment of the present application, the curing agent may include a substance selected from the group consisting of polydimethylsiloxane (PDMS), polyisocyanate, hexamethylene diisocyanate, ethylenimine, propylenimine, poly(ethylene glycol dimethacrylate) (PEGDMA), poly(ethylene glycol diactylate) (PEGDMA), dicumyl peroxide, dibenzoyl peroxide, tert-butylcumylperoxide, SYLGARD 184 elastomer curing agent, and a combination thereof. The type thereof is not particularly limited; however, according to an example of the present invention, a polydimethylsiloxane curing agent (PDMS curing agent) and SYLGARD 184 elastomer curing agent may be used.

In an embodiment of the present application, the content of the curing agent may be approximately 1 to approximately 30 parts by weight and may be preferably approximately 5 parts by weight to approximately 15 parts by weight with respect to 100 parts by weight of the polymer resin, and according to an embodiment of the present invention, it may be approximately 10 parts by weight.

Next, in an embodiment of the present application, the above-described manufacturing method for a photochromic element may include adding a photochromic dye to the resultant mixture.

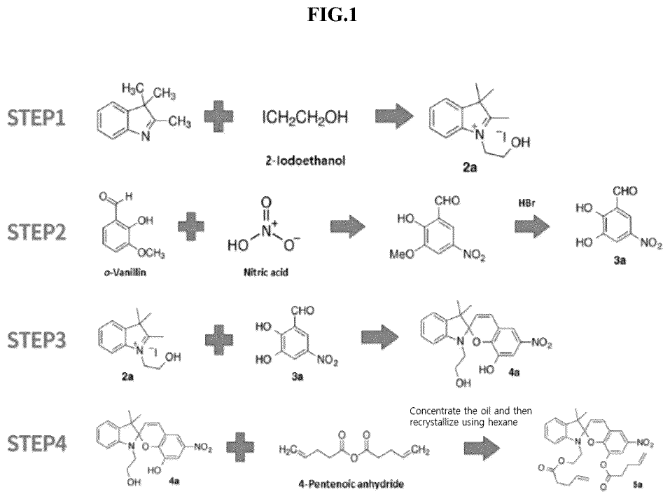

In an embodiment of the present application, the photochromic dye may include a substance selected from the group consisting of spiropyran, spirooxazine, naphthopyran, fulgimide, azobenzene, and combinations thereof, and according to an embodiment of the present invention, spiropyran may be used. In this case, the spiropyran may have properties that the color thereof changes to blue in response to UV. The spiropyran may be synthesized using a synthesis method shown in FIG. 1. On the other hand, the spiropyran may be represented by the following Chemical Formula 2.

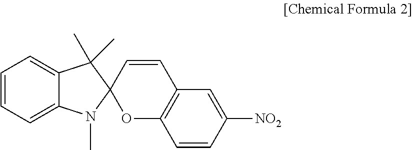 [SMILES: CN1c2ccccc2C(C)(C)C12C=Cc1cc([N+](=O)[O-])ccc1O2]

In an embodiment of the present application, the content of the photochromic dye may be approximately 0.1 to approximately 10 parts by weight and may be preferably approximately 0.1 to approximately 5 parts by weight with respect to 100 parts by weight of the mixture containing the polymer resin and the curing agent, and according to an example of the present invention, it may be approximately 2 parts by weight. On the other hand, in a case where the content of the photochromic dye is less than approximately 0.1 parts by weight with respect to 100 parts by weight of the mixture containing the polymer resin and the curing agent, the content of the photochromic dye may be too low, which results in a decrease in discoloration performance. In a case where it exceeds approximately 10 parts by weight, the content of the photochromic dye may be too high, which causes reduced dispersion stability in the polymer resin.

Next, in an embodiment of the present application, the above-described manufacturing method for a photochromic element may include adding a surfactant to the mixture to which the photochromic dye is added.

In an embodiment of the present application, the photochromic element may have improved physical properties such as flexibility and stretchability in a case where a surfactant is additionally contained.

In an embodiment of the present application, the surfactant may include a substance selected from the group consisting of Triton X-100 (trademark), myristyltrimethylammonium bromide, N-dodecyl-N,N-dimethyl-3-ammonio-1-propanesulfonate, a 3-(decyldimethylammonio)propanesulfonate inner salt zwitterionic detergent, 3-(N,N-dimethylmyristylammonio)propanesulfonate, Thesit (registered trademark), n-dodecyl β-D-maltoside, octyl β-D-glucopyranoside, and combinations thereof, and according to an example of the present invention, Triton X-100 may be used.

In this case, the Triton X-100 may be represented by the following Chemical Formula 3.

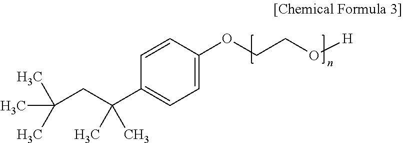

In an embodiment of the present application, the content of the surfactant may be approximately 0.01 to approximately 2 parts by weight and may be preferably approximately 0.01 parts by weight to approximately 1 part by weight with respect to 100 parts by weight of a mixture containing the polymer resin and the curing agent, and according to an example of the present invention, it may be approximately 0.1 to approximately 0.5 parts by weight. In this case, in a case where the content of the surfactant is less than approximately 0.01 parts by weight with respect to 100 parts by weight of a mixture containing the polymer resin and the curing agent, the effect of improving the physical properties of the photochromic element may be negligible since the content of the surfactant may be too small. In a case where the content of the surfactant exceeds approximately 2 parts by weight, it already exceeds a content that exhibits the effect of improving physical properties due to the surfactant, which may be uneconomical.

A second aspect of the present application provides
a photochromic element containing a polymer resin, a curing agent, a photochromic dye, and a surfactant, and an artificial skin including the photochromic element.

Although detailed descriptions for parts that overlap with the first aspect of the present application have been omitted, the content described for the first aspect of the present application may be equally applied to the second aspect, even in a case where the explanatory description is omitted.

Hereinafter, the photochromic element and the artificial skin according to the second aspect of the present application will be described in detail.

In an embodiment of the present application, the polymer resin may include, as a substance serving as a base for a photochromic element, a polymer resin selected from the group consisting of polydimethylsiloxane (PDMS), polyurethane, polyacrylic, polyepoxy, polyester, polystyrene (PS), polyacrylate (PA), and a combination thereof, and according to an example of the present invention, polydimethylsiloxane (PDMS) may be used.

In an embodiment of the present application, the curing agent may include a substance selected from the group consisting of polydimethylsiloxane (PDMS), polyisocyanate, hexamethylene diisocyanate, ethylenimine, propylenimine, poly(ethylene glycol dimethacrylate) (PEGDMA), poly(ethylene glycol diactylate) (PEGDMA), dicumyl peroxide, dibenzoyl peroxide, tert-butylcumylperoxide, SYLGARD 184 elastomer curing agent, and a combination thereof. The type thereof is not particularly limited; however, according to an example of the present invention, a PDMS curing agent and a SYLGARD 184 elastomer curing agent may be used.

In an embodiment of the present application, the photochromic dye may include a substance selected from the group consisting of spiropyran, spirooxazine, naphthopyran, fulgimide, azobenzene, and combinations thereof, and according to an example of the present invention, spiropyran may be used. In this case, the spiropyran may have such properties that the color thereof changes to blue in response to UV. The spiropyran may be synthesized using a synthesis method shown in FIG. 1.

In an embodiment of the present application, the surfactant may include a substance selected from the group consisting of Triton X-100 (trademark), myristyltrimethylammonium bromide, N-dodecyl-N,N-dimethyl-3-ammonio-1-propanesulfonate, a 3-(decyldimethylammonio)propanesulfonate inner salt zwitterionic detergent, 3-(N,N-dimethylmyristylammonio)propanesulfonate, Thesit (registered trademark), n-dodecyl β-D-maltoside, octyl β-D-glucopyranoside, and combinations thereof, and according to an example of the present invention, Triton X-100 may be used.

In an embodiment of the present application, the content of the curing agent may be approximately 1 to approximately 30 parts by weight and may be preferably approximately 5 to approximately 15 parts by weight with respect to 100 parts by weight of the polymer resin, and according to an example of the present invention, it may be approximately 10 parts by weight. In addition, the content of the photochromic dye may be 0.1 to 10 parts by weight and may be preferably approximately 0.1 to 5 parts by weight with respect to 100 parts by weight of a total weight of the polymer resin and the curing agent, and according to an example of the present invention, it may be approximately 2 parts by weight. On the other hand, in a case where the content of the photochromic dye is less than approximately 0.1 parts by weight with respect to 100 parts by weight of a mixture containing the polymer resin and the curing agent, the content of the photochromic dye may be too low, which results in a decrease in discoloration performance. In a case where it exceeds approximately 10 parts by weight, the content of the photochromic dye may be too high, which causes reduced dispersion stability in the polymer resin. In addition, the content of the surfactant may be approximately 0.01 to approximately 2 parts by weight and may be preferably approximately 0.01 to approximately 1 part by weight with respect to 100 parts by weight of a total weight of the polymer resin and the curing agent, and according to an example of the present invention, it may be approximately 0.1 to approximately 0.5 parts by weight. In this case, in a case where the content of the surfactant is less than approximately 0.01 parts by weight with respect to 100 parts by weight of a mixture containing the polymer resin and the curing agent, the effect of improving the physical properties of the photochromic element may be negligible since the content of the surfactant may be too small. In a case where the content of the surfactant exceeds approximately 2 parts by weight, it already exceeds a content that exhibits the effect of improving physical properties due to the surfactant, which may be uneconomical.

In an embodiment of the present application, the discoloration of the photochromic element is carried out within approximately 1 minute, and the decolorization may be carried out within approximately 10 minutes. Preferably, the discoloration is carried out within approximately 30 seconds, and the decolorization may be carried out within approximately 5 minutes. In this case, the discoloration may be carried out in a case where UV is applied, and the decolorization may be carried out in a case where the applied UV is cut off.

In an embodiment of the present application, in a case where the photochromic element is discolored, the photochromic element may exhibit a transmittance of approximately 45% to approximately 75% with respect to light having a wavelength of approximately 593 nm, and the transmittance may decrease as the time of UV irradiation elapses. On the other hand, in a case where the photochromic element is discolored, the photochromic element may exhibit a transmittance change of approximately 30% or more with respect to light having a wavelength of approximately 593 nm based on a transmittance before discoloration, and preferably, it may exhibit a transmittance change of approximately 50% or more.

In an embodiment of the present application, the photochromic element may exhibit a tensile strain of approximately 350% or more based on a tensile strength of approximately 1 MPa. That is, the photochromic element according to the present invention may have excellent physical properties as described above due to additionally containing a surfactant, and it may be suitably used as an artificial skin due to having excellent flexibility and excellent stretchability.

Hereinafter, examples of the present invention will be described in detail so that a person skilled in the art can easily carry out the examples of the present invention. However, the present invention may be embodied in various forms different from each other and thus is not limited to the examples described herein.

### Example 1. Manufacturing of Photochromic Element (Triton X: 0.1 wt %)

First, polydimethylsiloxane (PDMS) and as a curing agent, a polydimethylsiloxane curing agent (PDMS curing agent) SYLGARD 184 elastomer curing agent were mixed at a weight ratio of approximately 10:1.

Thereafter, 2 wt % of spiropyran synthesized according to a method in FIG. 1 was added to the above mixture, and 0.1 wt % of Triton X-100 was further added as a surfactant to improve physical properties, thereby manufacturing a gel-shaped photochromic element.

### Example 2. Manufacturing of Photochromic Element (Triton X: 0.3 wt %)

A photochromic element was manufactured using the same method except that in Example 1, the content of Triton X-100 as a surfactant was changed to 0.3 wt %.

### Example 3. Manufacturing of Photochromic Element (Triton X: 0.5 wt %)

A photochromic element was manufactured using the same method except that in Example 1, the content of Triton X-100 as a surfactant was changed to 0.5 wt %.

### Comparative Example. Manufacturing of Photochromic Element (Triton X: 0 Wt %)

A photochromic element was manufactured using the same method except that in Example 1, Triton X-100 as a surfactant was not added.

### Experimental Example 1. Measurement of the Discoloration Performance of Photochromic Element

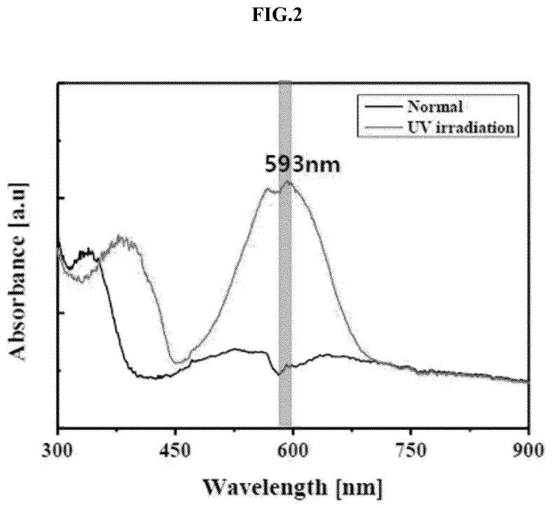

The UV absorbance of the photochromic element manufactured in Example 1 was measured, and the results are shown in FIG. 2.

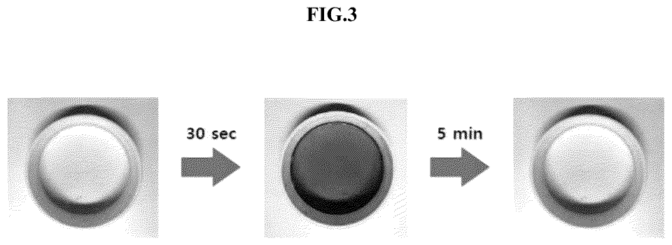

As shown in FIG. 2, a high absorbance was exhibited at a wavelength of approximately 593 nm, which could also be confirmed by the fact that the color of the photochromic element changed to blue as shown in FIG. 3. On the other hand, as shown in FIG. 3, the photochromic element manufactured according to Example 1 completed discoloration in approximately 30 seconds, and it was confirmed that decolorization was completed in approximately 5 minutes thereafter.

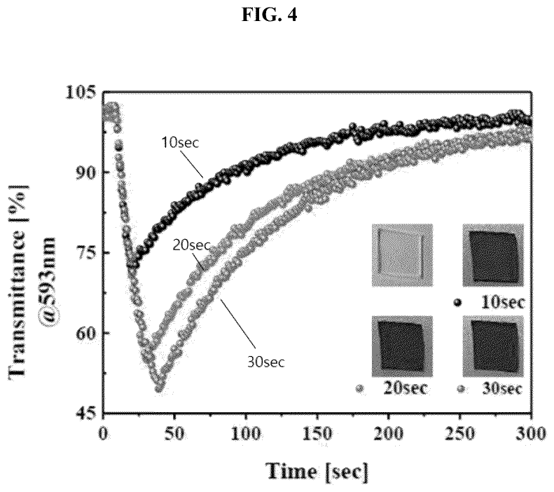

In addition, the transmittance of the photochromic element manufactured in Example 1 was measured over time, and the results are shown in FIG. 4.

As shown in FIG. 4, the photochromic element exhibited a transmittance change of approximately 53% or more at a time of approximately 30 seconds after UV irradiation, and it was confirmed that the photochromic element was decolorized to be transparent within approximately 5 minutes after stopping UV irradiation.

### Experimental Example 2. Measurement of Physical Properties of Photochromic Element

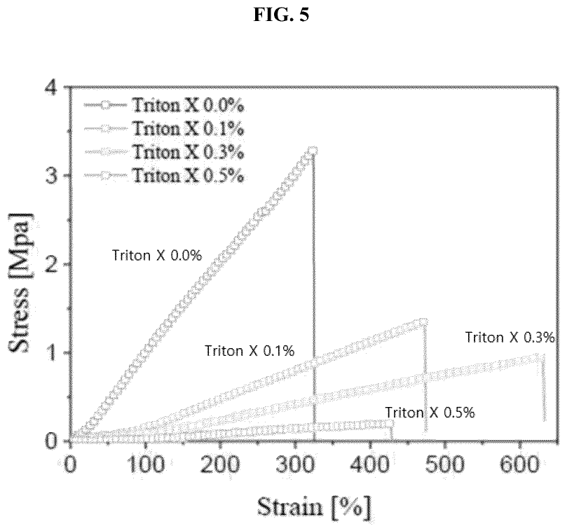

The physical properties of the photochromic elements manufactured in Examples 1 to 3 and Comparative Example were measured using UTM, and the results are shown in FIG. 5 (stress-strain curve).

As shown in FIG. 5, it could be confirmed that the photochromic elements manufactured according to examples of the present invention exhibit a tensile strain of two times or more than a tensile strain of the photochromic element according to the comparative example at a tensile strength that is lower by three times or more than the photochromic element according to the comparative example.

Through this, it could be confirmed that the photochromic elements manufactured according to examples of the present invention have flexibility and stretchability suitable for an artificial skin.

As described above, the present invention has been described in detail together with the preferred examples with reference to drawings. However, the scope of the technical idea of the present invention is not limited to these drawings and examples. Therefore, various modification examples or equivalent examples may exist within the scope of the technical idea of the present invention. Therefore, the scope of rights of the technical idea according to the present invention should be interpreted by the claims, and technical ideas within the scope equal or equivalent thereto should be interpreted as belonging to the scope of rights of the present invention.

1. A manufacturing method for a photochromic element, the manufacturing method comprising:
mixing a polymer resin and a curing agent;
adding a photochromic dye to the resultant mixture; and
adding a surfactant to a mixture to which the photochromic dye is added.

2. The manufacturing method of claim 1, wherein the polymer resin includes a polymer resin selected from the group consisting of polydimethylsiloxane (PDMS), polyurethane, polyacryl, polyepoxy, polyester, polystyrene (PS), polyacrylate (PA), and combinations thereof.

3. The manufacturing method for a photochromic element of claim 1, wherein the curing agent includes a substance selected from the group consisting of polydimethylsiloxane (PDMS), polyisocyanate, hexamethylene diisocyanate, ethylenimine, propylenimine, polyethylene glycol dimethacrylate (PEGDMA), poly(ethylene glycol diactylate) (PEGDMA), dicumyl peroxide, dibenzoyl peroxide, tert-butylcumylperoxide, SYLGARD 184 elastomer curing agent, and combinations thereof.

4. The manufacturing method of claim 1, wherein the photochromic dye includes a substance selected from the group consisting of spiropyran, spirooxazine, naphthopyran, fulgimide, azobenzene, and combinations thereof.

5. The manufacturing method of claim 1, wherein the surfactant includes a substance selected from the group consisting of Triton X-100 (trademark), myristyltrimethylammonium bromide, N-dodecyl-N,N-dimethyl-3-ammonio-1-propanesulfonate, a 3-(decyldimethylammonio)propanesulfonate inner salt zwitterionic detergent, 3-(N,N-dimethylmyristylammonio)propanesulfonate, Thesit (registered trademark), n-dodecyl β-D-maltoside, octyl β-D-glucopyranoside, and combinations thereof.

6. The manufacturing method of claim 1, wherein a content of the curing agent is approximately 1 to approximately 30 parts by weight with respect to 100 parts by weight of the polymer resin.

7. The manufacturing method of claim 1, wherein a content of the photochromic dye is approximately 0.1 to approximately 10 parts by weight with respect to 100 parts by weight of the mixture containing the polymer resin and the curing agent.

8. The manufacturing method of claim 1, wherein a content of the surfactant is approximately 0.01 to approximately 2 parts by weight with respect to 100 parts by weight of the mixture containing the polymer resin and the curing agent.

9. A photochromic element comprising:
a polymer resin;
a curing agent;
a photochromic dye; and
a surfactant.

10. The photochromic element of claim 9, wherein discoloration of the photochromic element is carried out within approximately 1 minute.

11. The photochromic element of claim 9, wherein decolorization of the photochromic element is carried out within approximately 10 minutes.

12. The photochromic element of claim 9, wherein when the photochromic element is discolored, the photochromic element exhibits a transmittance of approximately 45% to approximately 75% with respect to light having a wavelength of 593 nm.

13. The photochromic element of claim 9, wherein when the photochromic element is discolored, the photochromic element exhibits a transmittance change of approximately 30% or more with respect to light having a wavelength of approximately 593 nm based on a transmittance before discoloration.

14. The photochromic element of claim 9, wherein the photochromic element exhibits a tensile strain of approximately 350% or more based on a tensile strength of approximately 1 MPa.

15. An artificial skin comprising a photochromic element of claim 9.
